(19) United States
(12) Patent Application Publication
(10) Pub. No.: US 2016/0303549 A1
(43) Pub. Date: Oct. 20, 2016

(54) EXHAUST GAS TREATMENT CATALYST

(71) Applicant: MITSUBISHI HEAVY INDUSTRIES, LTD., Tokyo (JP)

(72) Inventors: Tomotsugu Masuda, Tokyo (JP); Koji Higashino, Tokyo (JP); Masatoshi Katsuki, Tokyo (JP)

(73) Assignee: MITSUBISHI HEAVY INDUSTRIES, LTD., Tokyo (JP)

(21) Appl. No.: 15/038,656

(22) PCT Filed: Apr. 10, 2014
(86) PCT No.: PCT/JP2014/060381

§ 371 Date: May 23, 2016

(30) Foreign Application Priority Data
Nov. 26, 2013 (JP) 2013-243962

(51) Int. Cl. B01J 29/072; B01J 23/86; B01D 53/94; B01J 23/30; B01J 35/00; B01J 23/72; B01J 23/889

(52) U.S. Cl. CPC B01J 29/072; B01J 23/72; B01J 23/868; B01J 23/8892; B01J 23/30; B01J 35/0006; B01D 53/945; B01D 2255/50; B01D 2255/20707; B01D 2255/20723; B01D 2255/2073; B01D 2255/20761; B01D 2255/20776; B01D 2255/20784

(57) ABSTRACT

An exhaust gas treatment catalyst comprises titanium oxide, tungsten oxide, vanadium oxide, and copper oxide and/or Cu/zeolite-coated catalyst, wherein the catalyst is provided with a nitrogen oxide removing capability in which nitrogen oxides contained in an exhaust gas are subjected to catalytic reduction in the presence of ammonia, and with CO and VOC removing capability.

### BACKGROUND OF THE INVENTION

1. Technical Field

The present invention relates to an exhaust gas treatment catalyst.

2. Background Art

NOx carbon monoxide (CO), volatile organic compounds (VOC) such as saturated hydrocarbons excluding methane and ethane, and unsaturated hydrocarbons such as ethylene, and the like are present in exhaust gases discharged from various industrial devices, for example, automobile engines, gas engines, gas turbines for aircraft and power generation, chemical plants, various factories, and the like.

Expensive oxidation catalysts prepared by using platinum (Pt) are used as exhaust gas treatment materials in order to remove CO and VOC in addition to reducing NOx.

Proposed in, for example, patent document 1 (Japanese Patent No. 4939082) is an exhaust gas treatment system in which for the purpose of reducing as discharge amount of CO in an exhaust gas treatment facility, noble metals are added to a denitration catalyst in a front stage to carry out denitration and partial oxidation of VOC and in which CO is oxidized and decomposed with a noble metal base catalyst in a rear stage.

Such the exhaust as treatment system presents a problem that the catalyst cost is increased as described above since noble metal catalysts prepared by using platinum (Pt) are used as both denitration and oxidation catalysts.

Many conventional technologies described in patent document 2 (JP-A 1995-213908), patent document 3 (JP-A 2000-130216), patent document 4 (JP-A 2009-202107), patent document 6 (Patent No. 4801461), and the like are available for denitration catalysts. However, none of them propose denitration catalysts that are satisfactory from the viewpoint of reducing catalyst costs. Further, according to patent document 5 (JP-A 2012-245111), platinum (Pt) is not used in an oxidation reaction of CO after denitration, but no improvement in the cost is proposed with respect to the denitration reaction itself.

### CITATION LIST

### Patent Documents

Patent document 1: JP-B 4939082.

Patent document 2: JP-A 1995-213908

Patent document 3: JP-A 2000-130216

Patent document 4: JP-A 2009-707107

Patent document 5: JP-A 2012-245411

Patent document 6: JP-B 4801461

In light of the situations described above, an object of the present invention is to provide an exhaust gas treatment catalyst which makes it possible to remove CO and VOC in addition to reducing NOx without bringing about an increase in the catalyst cost.

### SUMMARY OF INVENTION

The present inventors have repeated the investigations of a binary catalyst (multicomponent catalyst) which makes it possible to remove CO and VOC in addition to exerting a denitration performance, and they have arrived at the present invention.

That is, the exhaust gas treatment catalyst according to the present invention comprises titanium oxide, tungsten oxide, vanadium oxide, and copper oxide and/or a Cu/zeolite-coated catalyst, wherein the catalyst is provided with as nitrogen oxide removing capability in which nitrogen oxides contained in an exhaust gas are subjected to catalytic reduction in the presence of ammonia, and with a CO and VOC removing capability in order to achieve the object described above.

Also, the exhaust gas treatment catalyst according to the present invention contains 0.2 to 0.75 wt % of copper oxide in one embodiment. In the above exhaust gas treatment catalyst, the Cu/zeolite catalyst may be present together with or instead of the copper oxide. The Cu/zeolite-coated catalyst may be present suitably in an amount of 50 g to 200 g/m² as catalyst coating against a base material. That is, the Cu/zeolite-coated catalyst can be prepared by coating Cu/zeolite over the catalyst base material.

According to the present invention, provided is an exhaust gas treatment catalyst which makes it possible to remove CO and VOC in addition to reducing NOx without bringing about an increase in the catalyst cost.

### BRIEF DESCRIPTION OF DRAWINGS

FIG. 1 is a graph showing a NOx reduction rate in an example of the exhaust gas treatment catalyst according to the present invention.

FIG. 2 is a graph showing a CO reduction rate in an example of the exhaust gas treatment catalyst according to the present invention.

FIG. 3 is a graph showing a C₂H₄ reduction rate in an example of the exhaust gas treatment catalyst according to the present invention.

FIG. 4 is a graph showing a C₃H₈ reduction rate in an example of the exhaust gas treatment catalyst according to the present invention.

FIG. 5 is a graph showing an HCHO reduction rate in an example of the exhaust gas treatment catalyst according to the present invention.

FIG. 6 is a graph showing a CO reduction rate in an example of the CO-oxidizing catalyst which is adopted in the exhaust gas treatment system constituted by using the exhaust gas treatment catalyst according to the present invention.

FIG. 7 is a graph showing a C₂H₄ reduction rate in an example of the CO-oxidizing catalyst which is adopted in the exhaust gas treatment system constituted by using the exhaust gas treatment catalyst according to the present invention.

FIG. 8 is a graph showing as CO removing rate in an example of the exhaust gas treatment system constituted by using the exhaust gas treatment catalyst according to the present invention.

FIG. 9 is a graph showing an HCHO removing rate in an example of the exhaust gas treatment system constituted by using the exhaust gas treatment catalyst according to the present invention

FIG. 10 is a graph showing a C₂H₄ removing rate in an example of the exhaust gas treatment system constituted by using the exhaust gas treatment catalyst according to the present invention.

FIG. 11 is a graph showing a C₃H₈ removing rate in an example of the exhaust gas treatment system constituted by using the exhaust gas treatment catalyst according to the present invention.

### DESCRIPTION OF THE PREFERRED EMBODIMENTS

The exhaust gas treatment catalyst according to the present invention will be explained below in further detail.

### Exhaust Gas Treatment Catalyst According to the Present Invention

The exhaust gas treatment catalyst according to the present invention comprises titanium oxide, tungsten oxide, vanadium oxide, and copper oxide and/or Cu/zeolite-coated catalyst, wherein it is provided with a nitrogen oxide removing capability in which nitrogen oxides contained in an exhaust gas are subjected to catalytic reduction treatment in the presence of ammonia, and with a CO and VOC removing capability.

That is, the exhaust gas treatment catalyst according to the present invention comprises titanium oxide, tungsten oxide and vanadium oxide (first component), and copper oxide and/or Cu/zeolite-coated catalyst (second component). The exhaust gas treatment catalyst comprising the above components is provided with a CO-oxidizing capability and a VOC removing capability in addition to a nitrogen oxide removing capability in which nitrogen oxides contained in an exhaust gas are subjected to catalytic reduction treatment in the presence of ammonia. Also, the catalyst comprising the components described above makes it possible to reduce nitrogen oxides and decompose them into nitrogen and water which are harmless by adding ammonia (NH₃) to exhaust gases discharged from gas turbines, diesel engines, gas engines, or chemical plants such as a nitric acid plant and the like which have large load variations, and bringing them into contact with the above catalyst. In particular, providing the catalyst with the second component makes it possible to reduce nitrogen oxides contained in exhaust gases in the presence of ammonia and decompose them into nitrogen and water which are harmless even when a proportion of nitrogen dioxide based on nitrogen oxides contained in exhaust gases is large as is the case with in a low load applied in a gas turbine combined cycle (GTCC) power generation.

The exhaust gas treatment catalyst described above can be obtained by impregnating a base material comprising the first component with the second component and calcining it after drying. Also, the catalyst for removing nitrogen oxides and VOC can be obtained as well by adding a solvent to the first and second components, kneading them, subjecting the kneaded matter to extrusion molding, and calcining it after drying.

In the first component described above, the tungsten oxide and the vanadium oxide are added respectively in the amounts between 3 parts by weight and 25 parts by weight, and between 0.1 part by weight and 6 parts by weight based on 100 parts by weight of the titanium oxide. Setting such weight ratio makes it possible to sufficiently denitrate nitrogen monoxide contained in an exhaust gas.

The total amount of the components constituting the second component against the total amount of the fast and second components is controlled to between 1.0 wt % and 1.5 wt %. Further, when copper oxide is used for the second component, it is contained in an amount of 0.2 to 0.75 wt %, and in addition, 0.25 to 1.3 wt % of manganese oxide and 0.25 to 1.3 wt % of chromium oxide can be present. The Cu/zeolite catalyst may be used as well together with, or instead of, the copper oxide. The Cu/zeolite-coated catalyst is contained suitably in an amount of 50 g to 200 g/m² as coated on the base material. That is, in the above embodiment, the exhaust gas treatment catalyst can be used in the form of a catalyst prepared by coating the Cu/zeolite-coated catalyst on the catalyst base material.

Further, an exhaust gas treatment system can be constituted by using the exhaust gas. treatment catalyst according to the present invention. Such an exhaust gas treatment system as described above can be constituted, for example, by disposing the exhaust gas treatment catalyst according to the present invention in the front stream and disposing the CO-oxidizing catalyst having a CO-oxidizing catalytic capability in the rear stream.

In the exhaust gas treatment system constituted by using the exhaust gas treatment catalyst according to the present invention, a catalyst obtained, for example, by carrying silver on a double oxide can be used as the CO-oxidizing catalyst having a CO-oxidizing catalytic capability.

For example, yttrium manganate (YMnO₃) which is a publicly known double oxide can suitably be used as the double oxide.

Yttrium manganate can be produced, for example, by calcining a mixture comprising yttrium nitrate, manganese nitrate and citric acid. In this case, by-products such as YMn₂O_{5,} Y₇Mn₂O₇, Y₂O₃, Mn₂O₃ and the like are mixed therein in a certain case. The presence of such by-products contained in the carrier should cause no problems.

Also, yttrium manganate can be produced as well I crushing and mixing Y₂O₃ and Mn₂O₃ as raw materials and calcining the mixture.

The CO-oxidizing catalyst can be obtained by carrying silver on yttrium manganate alone obtained in the manner described above, or a mixture thereof with a publicly known carrier such as alumina and the like. It can be produced, for example, by introducing a carrier powder containing yttrium manganate into a solution of a soluble silver compound and calcining the resulting slurry. Also, the CO-oxidizing catalyst can be obtained as well by mixing a Ag powder or a Ag compound powder with a carrier powder, and calcining the mixture. In addition, the CO-oxidizing catalyst can be produced by applying publicly known catalyst molding methods such as molding into a honeycomb form, and the like.

The Ag particles suitably have a size of 10 to 20 nm.

### EXAMPLE 1

The exhaust gas treatment catalyst according to the present invention was prepared. This will be explained as Example 1.

A honeycomb catalyst (3.3 mm pitch, wall thickness: 0.5 mm) comprising 10 parts by weight of tungsten oxide (WO₃) and 4 parts by weight of vanadium oxide (V₂O₅) per 100 parts by weight of titanium oxide (TiO₂) was prepared by a known production method.

A solution was prepared by dissolving 152 g of copper nitrate trihydrate in 1 L of water, and the titanium oxide-tungsten oxide-vanadium oxide catalyst described above was dipped therein for 1 minute, whereby the catalyst was impregnated with copper nitrate so that 1.5 wt. % of copper oxide was contained therein as an increased content after being calcined. Subsequently, the titanium oxide-tungsten oxide-vanadium oxide catalyst carried thereon with copper nitrate was dried and then calcined at 500° C. for 5 hours. The catalyst thus obtained was referred to as a 1.5% CuO-impregnated honeycomb catalyst.

A solution was prepared by dissolving 152 g of copper nitrate trihydrate and 66 g of chromium nitrate nonahydrate in 1 L of water, and the titanium oxide-tungsten oxide-vanadium oxide catalyst described above was dipped therein for 1 minute, whereby the catalyst was impregnated with copper nitrate and chromium nitrate so that 0.75 wt % of copper oxide and 0.75 wt % of chromium oxide were contained therein as an inner content after calcined. Subsequently the titanium oxide-tungsten oxide-vanadium oxide catalyst carried thereon with copper nitrate and chromium nitrate was dried and then calcined at 500° C. for 5 hours. The catalyst thus obtained was referred to as a 1.5 CuO+Cr₂O₃imprepnated honeycomb catalyst.

A solution was prepared by dissolving 46 g of manganese nitrate hexabydrate and 152 g of copper nitrate trihydrate in 1 L of water, and the titanium oxide-tungsten oxide-vanadium oxide catalyst described above was dipped therein for 1 minute, whereby the catalyst was impregnated with manganese nitrate and copper nitrate so that 0.75 wt % of manganese oxide and 0.75 wt % of copper oxide were contained therein as an increased content after being calcined. Subsequently, the titanium oxide-tungsten oxide-vanadium oxide catalyst carried thereon with copper nitrate and chromium nitrate was dried and was then calcined at 500° C. for 5 hours. The catalyst thus obtained was referred to as a 1.5% Mn₂O₃+CuO-impregnated honeycomb catalyst.

A solution was prepared by dissolving 137 g of manganese nitrate hexahydrate and 229 g of copper nitrate trihydrate in 1 L of water, and the titanium oxide-tungsten oxide-vanadium oxide catalyst described above was dipped therein for 1 minute, whereby the catalyst was impregnated with manganese nitrate and copper nitrate so that 2.25 wt % of manganese oxide and 2.25 wt % of copper oxide were contained therein as an increased content after being calcined. Subsequently, the titanium oxide-tungsten oxide-vanadium oxide catalyst carried thereon with copper nitrate and chromium nitrate was dried and was then calcined at 500° C. for 5 hours. The catalyst thus obtained was referred to as a 4.5% Mn₂O₃+CuO-impregnated honeycomb catalyst.

The Cu/zeolite-coated catalyst was prepared by mixing a zeolite catalyst powder exchanged with as copper ion with an alumina, sol and a silica sol to prepare a slurry solution, coating the slurry solution on a base material (cell number: 80 cpsi, pitch: 2.84 mm, wall thickness: 0.41 mm) comprising the first component so that the catalyst coating amount was 100 g/m², subjecting the coated base material to hot air drying, and then calcining it at 500° C. for 5 hours. The coating amount is desirably 50 to 200 g/m² from the viewpoint of a pressure loss of the catalyst and inhibiting ammonia oxidation of a reducing agent used for denitration reaction.

### Performance Test

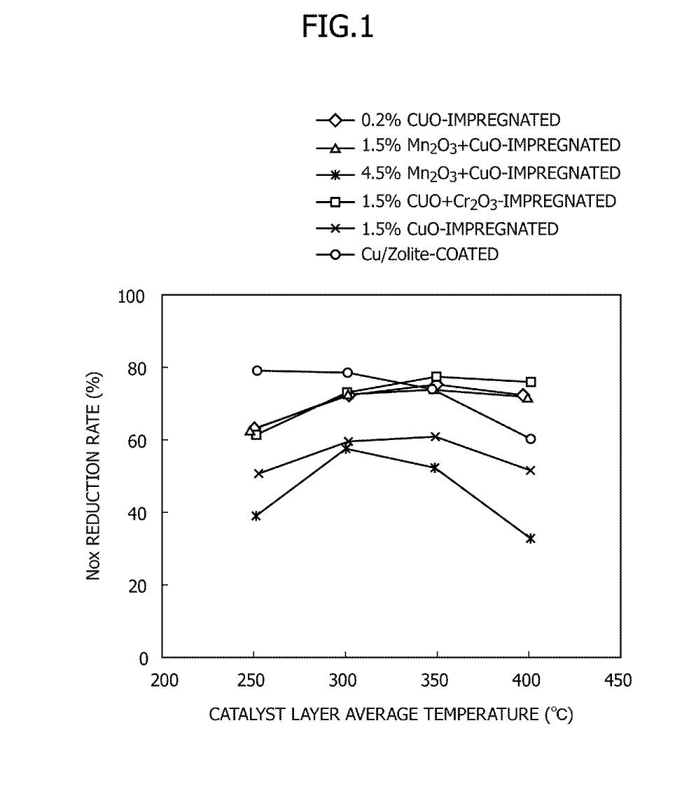

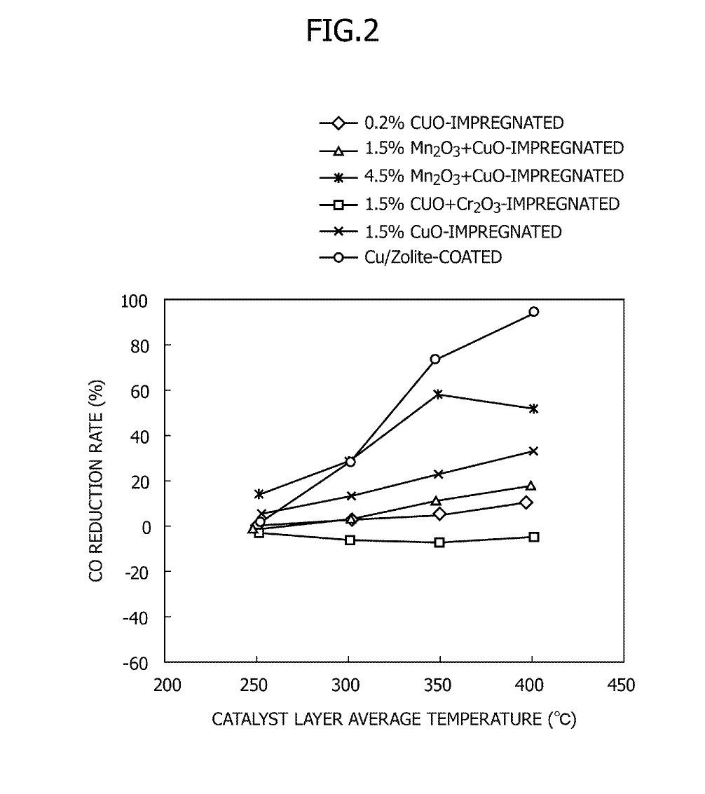

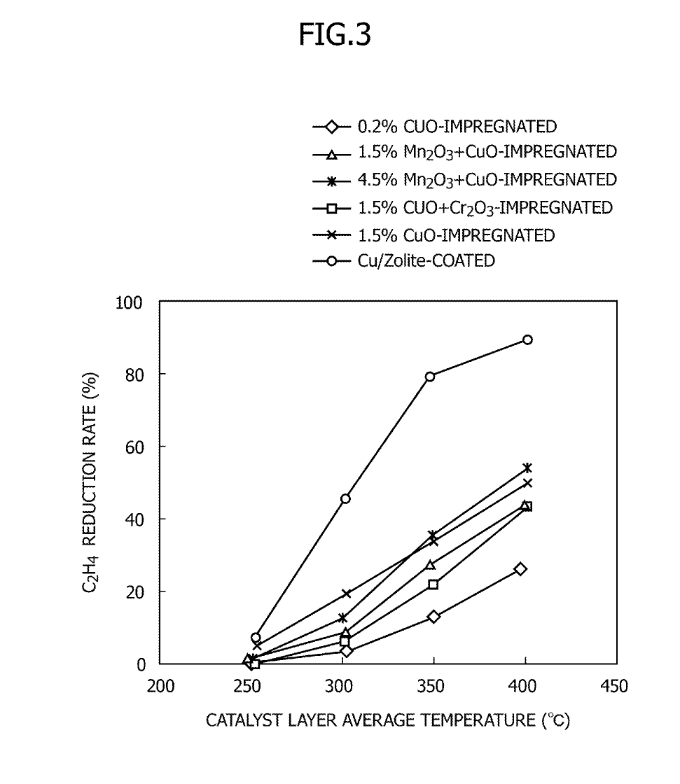

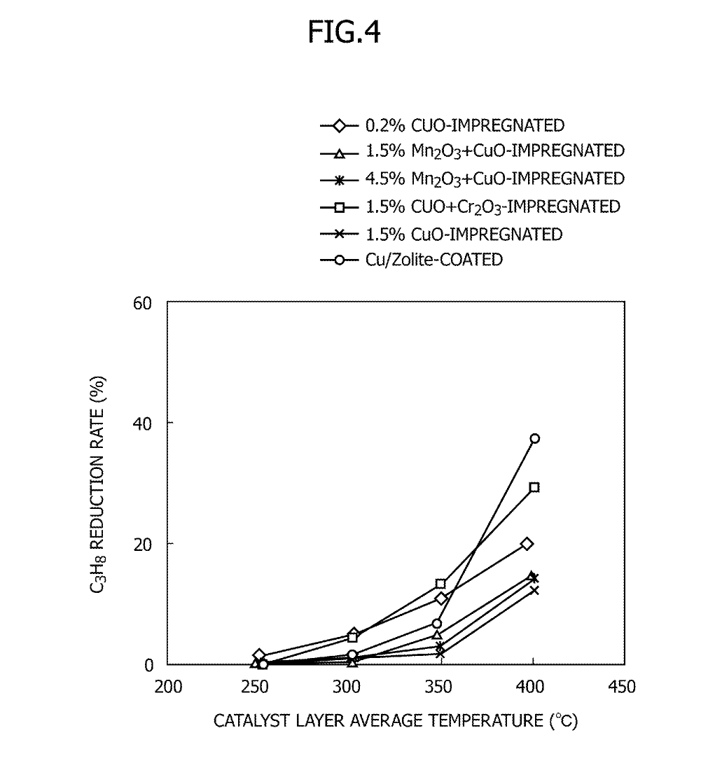

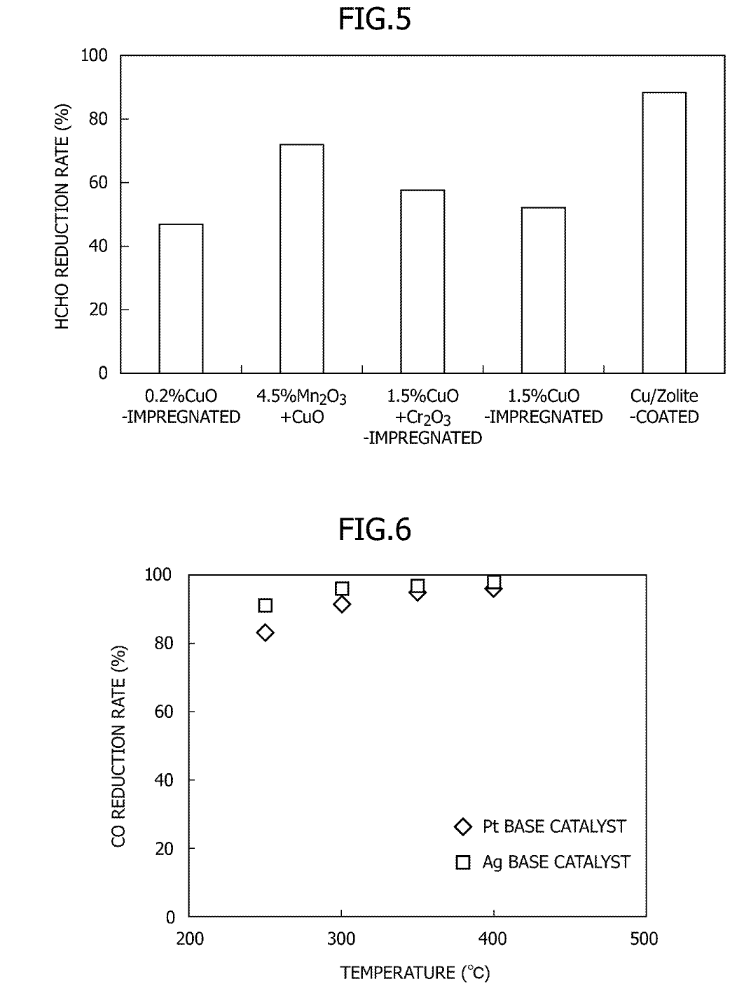

The denitration performances and the CO and VOC oxidation performances of the Cu-impregnated honeycomb catalysts and the Cu/zeolite-coated catalyst are shown in FIGS. 1 to 5. The test conditions thereof are shown in Table 1.

TABLE 1
Evaluation conditions

| Composition | Unit | Concentration |
|---|---|---|
| CO | ppmvd | 63 |
| HCHO | ppmvd | 13 |
| C₂H₄ | ppmvd | 13 |
| C₃H₈ | ppmvd | 13 |
| NOx | ppmvd | 63 |
| NH₃/NOx | — | 1.0 |
| O₂ | % vd | 13 |
| CO₂ | % vd | 7 |
| N₂ | — | balance |
| Moisture | % vd | 9 |
| AV value | Nm/hr | 50 |
| SV value | 1/hr | 50,000 |
| Temperature | ° C. | 250, 300, 350, 400 |

In the drawings, the term “honeycomb catalyst” is omitted. It has been found from the above results that the denitration performance is reduced when an impregnated amount of Cu is 1.5 wt % or more, but if it is 0.75 wt % or less (1.5 wt % Cu+Cr-impregnated honeycomb catalyst, 1.5 wt % Cu+Mn-impregnated honeycomb catalyst), the denitration performance is not reduced, and the oxidation performances of CO and C₂H₄ are notably enhanced.

As shown above, using the catalyst which is excellent in Co and VOC oxidation performance makes it possible to reduce an amount of a platinum base oxidation catalyst placing focus on oxidation of CO which is to be set in the rear stream of the system.

Also, it has been found that the Cu/zeolite-coated catalyst can be enhanced in a denitration performance at low temperature and is excellent in an oxidation performance of CO and C₂H₄, so that it is suited to a process in which denitration and oxidation of CO and VOC are required at a low temperature of 350° C. or lower.

### EXAMPLE 2

Determined were the effects of a case in which the 1.5 wt % Cu+Cr-impreprated honeycomb catalyst which had been confirmed to have an improving effect of an oxidation performance of CO and VOC in Example 1 was applied as the exhaust gas treatment catalyst provided with a nitrogen oxide removing capability and a CO and VOC removing capability in the exhaust gas treatment system constituted by using the exhaust gas treatment catalyst according to the present invention.

The CO-oxidizing catalyst was prepared in the following manner, and a catalytic capability thereof was determined in advance.

A carrier powder comprising yttrium manganate (YMnO₃) was added to a silver nitrate aqueous solution so that an amount of Ag was 3 atomic % based on the number of Y atoms, and the mixture was stirred for 30 minutes. The slurry thus obtained was coated on the surface of a cordierite-made honeycomb of 150 mm×150 mm×length 300 min. This was dried at 120° C. for 3 hours and then calcined in the air for 1 hour. An amount of yttrium manganate carried on the base material obtained above was 40 g/L, and a carried amount of Ag in terms of the metal was 0.69 g/L. The Ag particles carried on yttrium manganate had a size of 10 nm to 20 nm. This was referred to as a CO-oxidizing catalyst of a Ag base.

The CO-oxidizing catalyst prepared in the manner described above was used to evaluate performances on test conditions shown in the following Table 2.

TABLE 2
Evaluation conditions of CO-oxidizing catalyst

| Composition | Unit | Concentration |
|---|---|---|
| CO | ppmvd | 63 |
| HCHO | ppmvd | 13 |
| C₂H₄ | ppmvd | 13 |
| C₃H₈ | ppmvd | 13 |
| O₂ | % vd | 13 |
| CO₂ | % vd | 7 |
| N₂ | — | balance |
| Moisture | % vd | 9 |
| SV value | 1/hr | 120,000 |
| Temperature | ° C. | 250, 300, 350, 400 |

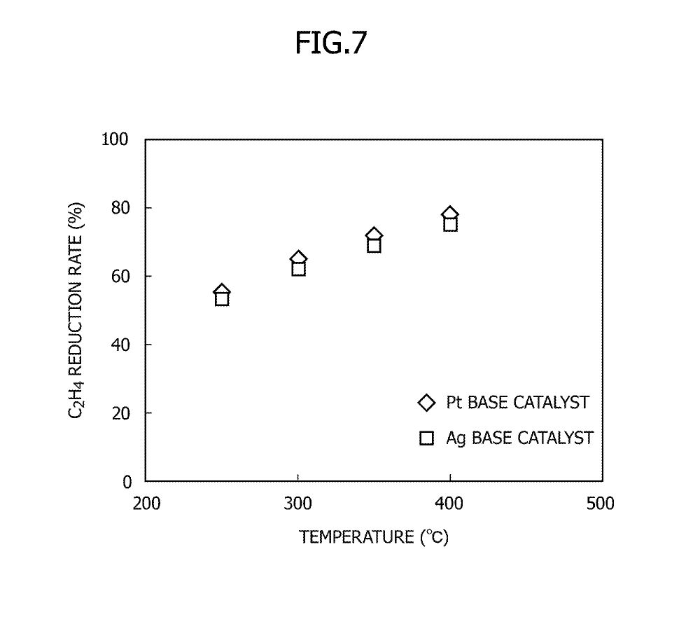

The CO-oxidizing catalyst prepared in the manner described above is a Ag base catalyst which is used as an oxidation catalyst for GTCC and which is expected to exert a CO-oxidizing; performance at a low cost. The results obtained by evaluating the performances of the above CO-oxidizing catalyst are shown in FIGS. 6 and 7. It was confirmed from the above results that the CO-oxidizing catalyst was excellent in reducing C₂H₄ and excellent as well in oxidizing CO.

A catalyst which is a commercial Pt base oxidation catalyst and which is prepared by carrying 1.0 wt % platinum (Pt) on a metal carrier in an amount of 100 g/m² was used as a Pt base catalyst for control.

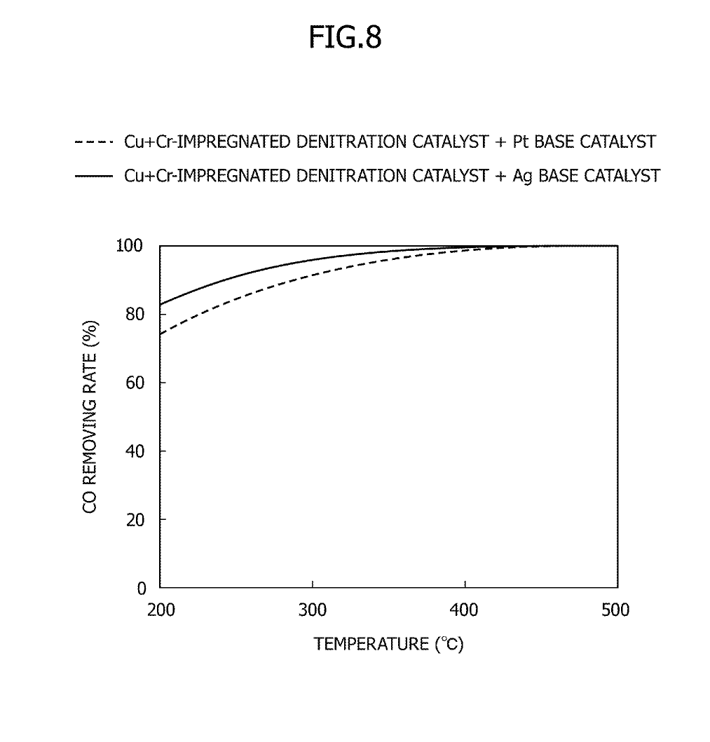

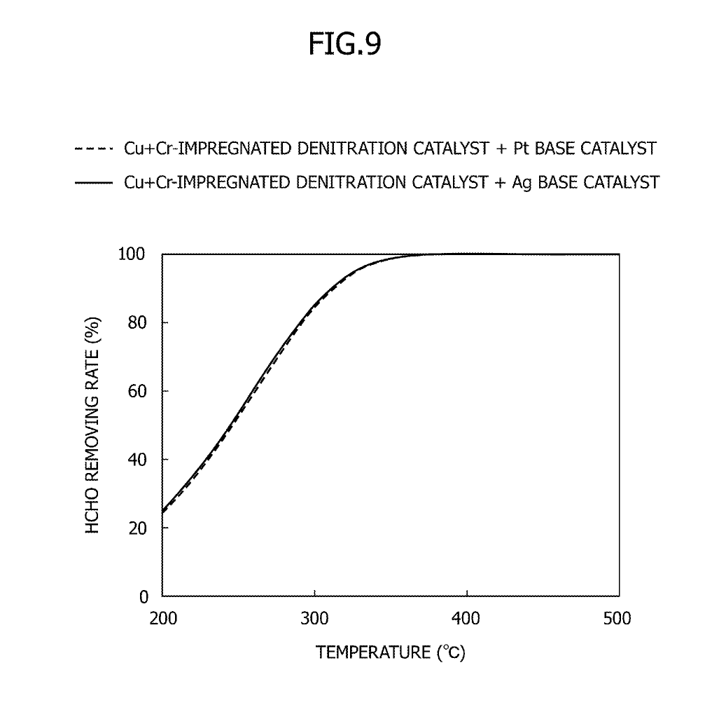

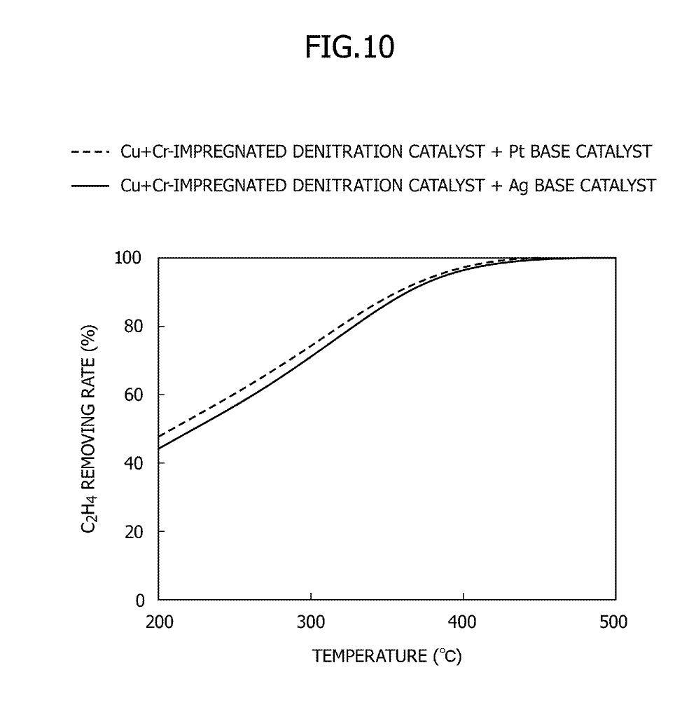

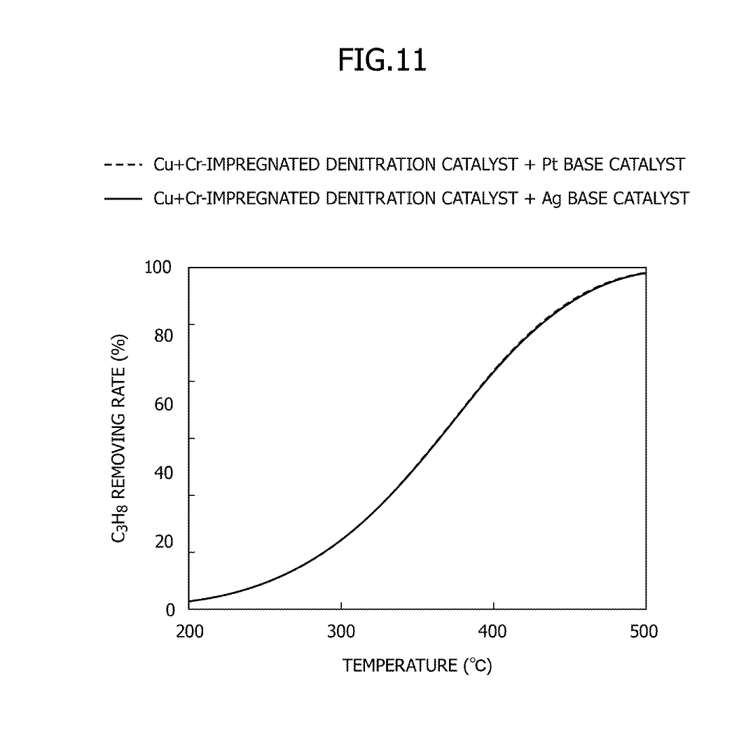

The oxidation reaction rates were calculated based on the results described above, and the performances of an exhaust gas treatment system according to a form in which the honeycomb catalyst (1.5 wt % Cu+Cr-impregaated honeycomb catalyst) described above was provided in the front stream and in which the CO-oxidizing catalyst was provided in the rear stream were calculated on a trial base (honeycomb catalyst: AV=12 Nm/hr, SV=12,000 hr⁻¹; CO-oxidizing catalyst: SV=120,000 hr⁻¹). The results thereof are shown in FIG. 8 to FIG. 11.

The systems according to a form in which the Pt base catalyst described previously in FIGS. 6 and 7 was used as the CO-oxidizing catalyst are shown as well.

It has been found from the results described above that the exhaust gas treatment system constituted by using the1.5 wt % Cu+Cr-impregnated honeycomb catalyst is an exhaust gas treatment system which is improved in an oxidation performance of CO and VOC. That is, it has been found that applying the CO-oxidizing catalyst of a Ag base which is excellent in oxidizing CO makes it possible to provide an exhaust gas treatment system which is comparable to a system constituted by using platinum (Pt) and which is free of Pt in raw materials, reducing the cost of the catalyst to a large extent.

1. An exhaust gas treatment catalyst comprising titanium oxide, tungsten oxide, vanadium oxide, and copper oxide and/or a Cu/zeolite-coated catalyst, wherein the catalyst has a nitrogen oxide removing capability in which nitrogen oxides contained in an exhaust gas are subjected to catalytic reduction in the presence of ammonia, and with CO and VOC removing capability.

2. The exhaust gas treatment catalyst according to claim 1, wherein the copper oxide is present in an amount of 0.2 to 0.75 wt %.

3. The exhaust gas treatment catalyst according to claim 1, wherein the Cu/zeolite-coated catalyst is present in an amount of 50 g to 200 g/m² as coating over the base material.
